(19) United States
(12) Patent Application Publication
(10) Pub. No.: US 2009/0244617 A1
(43) Pub. Date: Oct. 1, 2009

(54) FACSIMILE APPARATUS AND METHOD OF OUTPUTTING DISTRIBUTION DESTINATION INFORMATION

(75) Inventor: Tetsuro Matsutani, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/413,437

(22) Filed: Mar. 27, 2009

(30) Foreign Application Priority Data
Mar. 28, 2008 (JP) 2008088609

(51) Int. Cl. G06F 3/12

(52) U.S. Cl. 358/1.15

(57) ABSTRACT

A facsimile apparatus, including: a receiving device configured to receive facsimile information; a facsimile information storing device configured to store the facsimile information received by the receiving device; a distribution destination storing device configured to store an addressee of the facsimile information and distribution destination information indicating a distribution destination of the facsimile information addressed to the addressee, in a state in which the distribution destination information is corresponded to the addressee; and a controller configured to execute controls for operations of the facsimile apparatus, wherein the controller includes an outputting section configured to output the distribution destination information stored in the distribution destination storing device in correspondence with the addressee.

### CROSS REFERENCE TO RELATED APPLICATION

The present application claims priority from Japanese Patent Application No. 2008-088609, which was filed on Mar. 28, 2008, the disclosure of which is herein incorporated by reference in its entirety.

### BACKGROUND OF THE INVENTION

1. Field of the Invention

The present invention relates to a facsimile apparatus.

2. Description of the Related Art

There is conventionally known a facsimile apparatus having a facsimile function in which data sent from an addresser is received via a communication line, and the received data is converted to output an original document, and in which an original document is read to send the read data to an addressee via the communication line. Relating to this facsimile apparatus, Patent Document 1 (Japanese Patent Application Publication No. 2000-224347) discloses a facsimile system in which, in a facsimile system for sending, a cover sheet for being sent to a facsimile system for receiving is automatically produced and attached to facsimile documents.

### SUMMARY OF THE INVENTION

However, in the facsimile system disclosed by the above-described Patent Document 1, detailed information relating to the addressee which is to receive sent facsimile documents is not described on the produced cover sheet. Thus, where the facsimile system for receiving the facsimile documents including the cover sheet is installed in a company in which a plurality of users share the facsimile system, for example, and where the facsimile system is further installed in an environment in which the users are located over a relatively wide area in the company, whereabouts (i.e., a distribution destination) of the addressee of the received facsimile documents is not immediately recognized.

Thus, a distributor who distributes the received facsimile documents to the addressee has to ask people around the distributor about the whereabouts (i.e., the distribution destination) of the addressee of the facsimile documents, or has to check the whereabouts with a location list and a seating chart each of which is separately prepared. Thus, there arises a problem in which the distributor has to check the whereabouts (i.e., the distribution destination) of the addressee of the received facsimile documents with effort.

This invention has been developed in view of the above-described situations, and it is an object of the present invention to provide a facsimile apparatus which permits a user to check a distribution destination of received facsimile information without effort.

The object indicated above may be achieved according to the present invention which provides a facsimile apparatus, comprising: a receiving device configured to receive facsimile information; a facsimile information storing device configured to store the facsimile information received by the receiving device; a distribution destination storing device configured to store an addressee of the facsimile information and distribution destination information indicating a distribution destination of the facsimile information addressed to the addressee, in a state in which the distribution destination information is corresponded to the addressee; and a controller configured to execute controls for operations of the facsimile apparatus, wherein the controller includes an outputting section configured to output the distribution destination information stored in the distribution destination storing device in correspondence with the addressee.

The object indicated above may also be achieved according to the present invention which provides a method of outputting distribution destination information, the method comprising the steps of: (a) receiving facsimile information addressed to an addressee; (b) specifying, on the basis of the facsimile information received in step (a), distribution destination information that indicates a distribution destination of the received facsimile information and that is stored in correspondence with the addressee; and (c) outputting the distribution destination information specified in step (b) in correspondence with the addressee.

In the facsimile apparatus constructed as described above, a person who distributes, to an addressee, a fax recorded sheet, i.e., a recording sheet on which the facsimile information is recorded can check a distribution destination of the received fax recorded sheet without effort as long as the person sees the distribution destination information.

### BRIEF DESCRIPTION OF THE DRAWINGS

The objects, features, advantages, and technical and industrial significance of the present invention will be better understood by reading the following detailed description of a preferred embodiment of the invention, when considered in connection with the accompanying drawings, in which:

FIG. 1 is a perspective view showing an external construction of a Multi Function Device (MFD);

FIG. 2 is a block diagram showing a general configuration of a controller of the MFD;

FIG. 3A is a view showing an addresses table, and FIG. 3B is a view showing a distribution destination information table;

FIG. 4 is a flow-chart showing a received fax recording processing;

FIGS. 5A-5D are views each showing a display screen responsive to an operation of a user;

FIG. 6 is a flow-chart showing a distribution destination information processing;

FIGS. 7A-7D are views each showing a display screen responsive to an operation of the user;

FIGS. 8A-8E are views each showing a display screen responsive to an operation of the user;

FIG. 9 is a flow-chart showing a distribution destination information superposing processing;

FIGS. 10A-10D are views each showing a display screen responsive to an operation of the user; and

FIGS. 11A-11C are views each showing a display screen responsive to an operation of the user.

### DESCRIPTION OF THE PREFERRED EMBODIMENT

Hereinafter, there will be described a preferred embodiment of the present invention by reference to the drawings.

A Multi Function Device (MFD) 1 integrally includes a printer section 2 at its lower portion, a scanner section 3 at its upper portion, and an operational panel 4 in front of the scanner section 3. The MFD 1 has several functions such as a scanner function, a copying function, a facsimile function, and a printer function,

It is noted that the MFD 1 further has functions such as (a) a function in which where the MFD 1 is connected to an external device, e.g., a USB memory, a digital camera, a personal computer, and so on, images or characters are recorded on a recording sheet on the basis of data received from the external device, and (b) a function in which images or characters are displayed on a Liquid Crystal Display (LCD) 41 on the basis of data received from the external device.

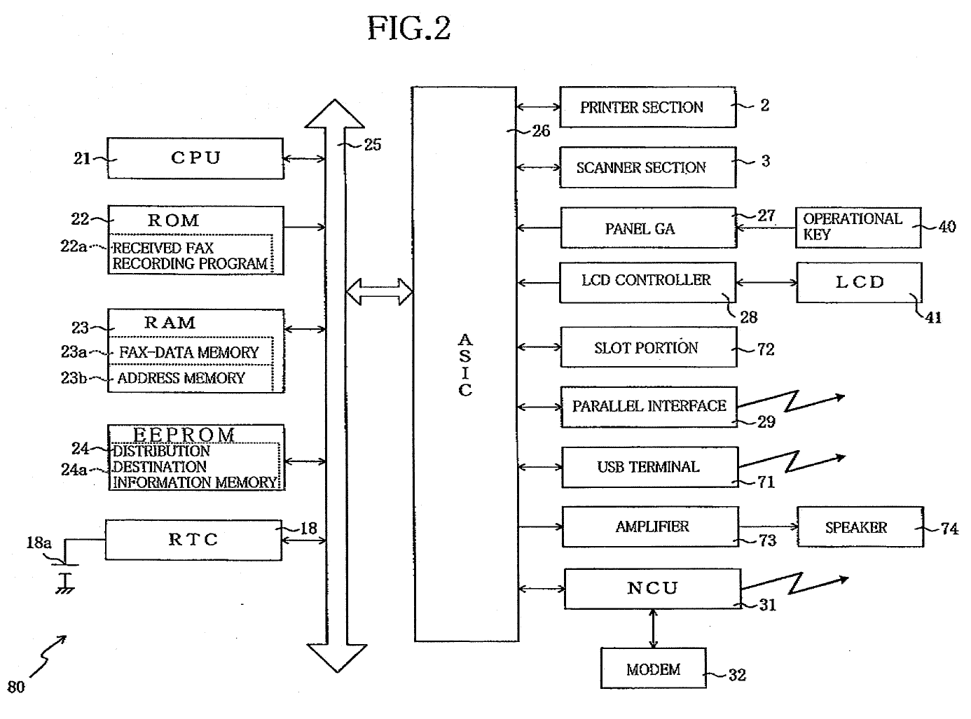

An opening 11 is formed in a front portion of a printer section 2. In the opening 11, a sheet-supply tray 15 and a sheet-discharge tray 16 are provided so as to be superposed on each other in a vertical direction such that each of the sheet-supply tray 15 and the sheet-discharge tray 16 is partly exposed from the opening 11. Recording sheets stacked on the sheet-supply tray 15 are supplied, one by one, into the printer section 2. After a desired image is recorded on the supplied recording sheet, the recording sheet is discharged onto the sheet-discharge tray 16.

Where the MFD 1 functions as a receiving device of a facsimile, facsimile information (hereinafter referred to as “fax”) sent from an addresser (i.e., a sender) is stored in a fax-data memory 23a (with reference to FIG. 2) which will be described below. When a user commands recording of images or characters on the basis of the received fax, that is, the user commands a recording operation on the basis of the received fax, the images or characters are recorded on the recording sheet by the printer section 2 on the basis of the received fax.

The scanner section 3 is constituted as what is called a flat-bed scanner. A document cover 30 is provided as a top plate of the MFD 1. Below the document cover 30, a platen glass, not shown, is disposed. A document is placed on the platen glass and read by the scanner section 3 in a state in which the document is covered by the document cover 30. Where the MFD 1 functions as a sending device of the facsimile, a document to be sent to an addressee (i.e., a receiver) is read by the scanner section 3, and data read by the scanner section 3 is sent to the addressee.

The operational panel 4 is a component of the MFD 10 through which the user operates the printer section 2 and the scanner section 3. On the operational panel 4, there are provided an LCD 41 and various operational keys 40 such as function selecting keys 40a, numeric keys 40b, direction keys 40c, a determination key 40d, a user ID confirmation key 40e, and so on.

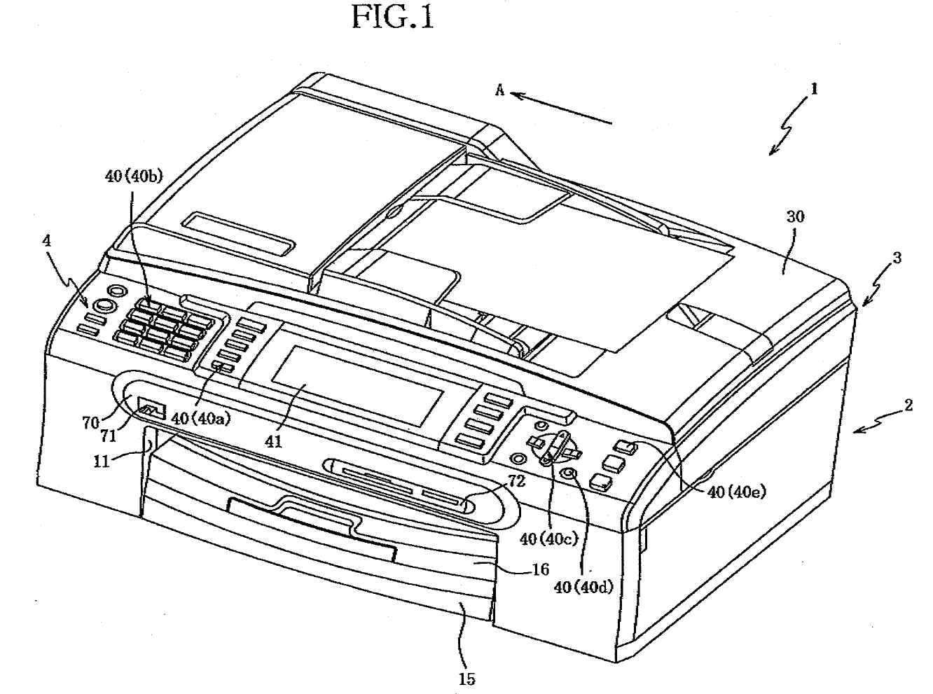

The function selecting keys 40a are keys for commanding execution of operations for realizing the scanner function, the copying function, the facsimile function, the printer function, and so on. The numeric keys 40b are keys for inputting a number of copying, a facsimile number, and so on. The direction keys 40c are keys for moving a position of a cursor displayed on the LCD 41. The determination key 40d is a key for commanding execution of various operations. The user ID confirmation key 40e is a key for commanding execution of a processing for verifying a user ID assigned to a user in order to verify whether the user intending to use the MFD 1 has an authority to use the MFD 1.

Where a predetermined command is inputted to the MFD 1 through any of the operational keys 40, an operation of the MFD 1 is controlled by a controller 80 (with reference to FIG. 2) in response to the command. It is noted that the MFD 1 is configured to be operated on the basis of commands transmitted from the external computer via a printer driver, a scanner driver, and the like in addition to the commands inputted through the operational keys 40.

Where a direction indicated by arrow A in FIG. 1 is defined as a widthwise direction of the LCD 41, the LCD 41 has an oblongly rectangular shape having a depth-to-width ratio of 3:8. More specifically, the LCD 41 includes two displays arranged side by side in the direction indicated by the arrow A. Each of the two displays has a depth-to-width ratio of 3:4. It is noted that FIG. 1 is shown by ignoring the ratio. Further, what is called a touch panel is integrally provided on the LCD 41. When any of various button images displayed on the LCD 41 is selected or touched by the user, a command assigned to the selected button image is inputted.

A connection panel 70 is provided under the operational panel 4 and above the opening 11. The connection panel 70 is provided with a USB terminal 71 at its left end portion. The USB terminal 71 is a connector terminal for connecting the external device and the MFD 1 via USB connecting so as to be communicable with each other.

The connection panel 70 is provided with a slot portion 72 at its right end portion. The slot portion 72 includes a plurality of card slots in each of which a memory card (i.e., a card-type memory) can be inserted or mounted. When the memory card is inserted into any of the card slots, the controller 80 (with reference to FIG. 2) described below can read image data from the inserted memory card to display an image on the LCD 41 on the basis of the read image data and to record the image on the recording sheet on the basis of the read image data.

There will be explained, with reference to FIG. 2, a general configuration of the controller 80 for executing controls of operations of the MFD 1. FIG. 2 is a block diagram showing the general configuration of the controller 80. The controller 80 is configured to perform the controls over the operations of the MFD 1 including the printer section 2, the scanner section 3, and the operational panel 4.

The controller 80 is essentially constituted by a microcomputer including a Central Processing Unit (CPU) 21, a Read Only Memory (ROM) 22, a Random Access Memory (RAM) 23, and an Electrically Erasable and Programmable ROM (EEPROM) 24, and is connected to an Application Specific Integrated Circuit (ASIC) 26 via a bus 25.

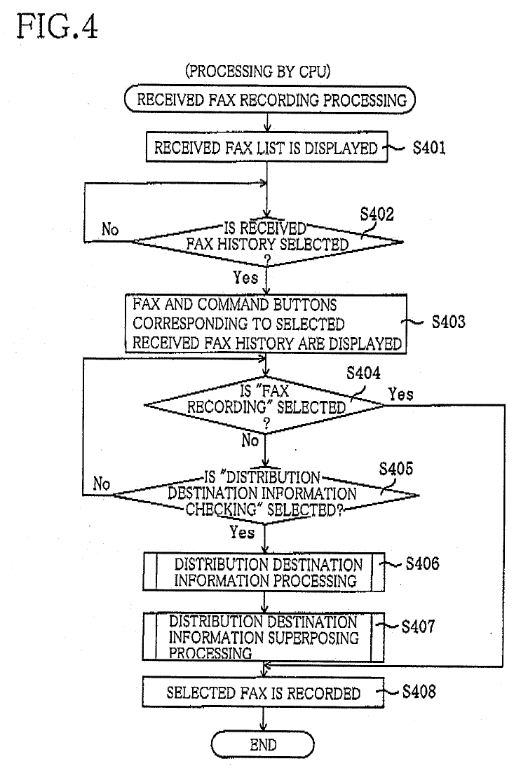

The CPU 21 functions as a processor that controls the MFD 1 as a whole and is operated on the basis of a program stored in the ROM 22. The ROM 22 stores the program for controlling the various operations of the MFD 1. For example, the ROM 22 stores a received fax recording program 22a as a program for executing a received fax recording processing indicated by a flow-chart in FIG. 4.

This received fax recording processing is a processing in which images or characters are recorded on the recording sheet on the basis of user-selected fax which is stored in a fax-data memory 23a (i.e., a facsimile information storing device) described below after having been received by the MFD 10 in the facsimile function. In particular, the received fax recording processing is a processing in which a destination of distribution (hereinafter may be referred to as a “distribution destination”) of a recording medium (a recording sheet in this MFD 1) having been subjected to the recording operation on the basis of the received fax can be recorded by superposing the destination on images recorded on the recording sheet. It is noted that, hereinafter, terms “images or characters are recorded on the recording sheet on the basis of the received fax” may be simply referred to as “the fax is recorded on the recording sheet”. Further, hereinafter, “the recording sheet on which the fax is recorded” may be simply referred to as a “fax recorded sheet”. Furthermore, hereinafter, terms “the recorded sheet on which the fax sent from the addresser is recorded” may be referred to as “the fax recorded sheet sent from the addresser” for easy understanding purpose.

The RAM 23 is used as a storage area or a working area which temporarily stores various data used when the CPU 21 executes the program and includes the fax-data memory 23a and an address memory 23b.

The fax-data memory 23a is an area for storing the fax received in the facsimile function and stores the received fax, date and time of receiving the fax, and a facsimile number of the addresser having sent the fax, in a state in which the received fax is corresponded to the date and time and the facsimile number.

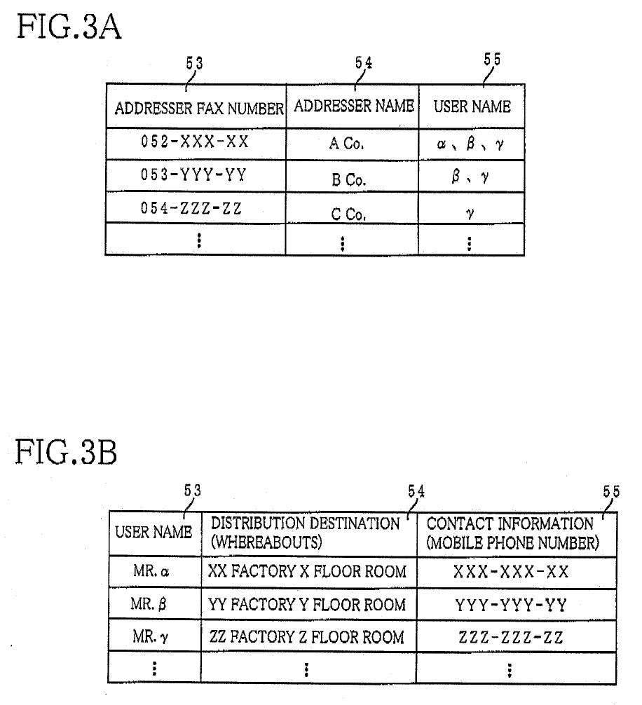

The address memory 23b as an addressee candidate storing device is an area for storing an addresser(s) and an addressee candidate(s) having a possibility of receiving the fax sent from the respective addresser(s) in a state in which the addresser is corresponded to the addressee candidate. For example, the address memory 23b stores an addresses table shown in FIG. 3A.

As shown in FIG. 3A, the addresses table stores an addresser fax number 50, an addresser name 51, and a user name 52 as the candidate for receiving the fax sent from the addresser in correspondence with each other. For example, the addresses table stores “052-XXXX-XXX” as the addresser fax number 50, “A Co.” (i.e., company A) as its addresser name, and “Mr. α”, “Mr. β” and “Mr. γ” each as the user name which is the candidate for receiving the fax sent from the addresser.

The EEPROM 24 is a rewritable non-volatile memory and includes a distribution destination information memory 24a as a distribution destination storing device. The distribution destination information memory 24a is an area for storing users (i.e., the addressee of the fax) and distribution destination information indicating the distribution destination of the fax recorded sheet addressed to the addressee, in a state in which the distribution destination information is corresponded to the addressee. The distribution destination information indicates, when the fax addressed to any of the users is received, where the fax recorded sheet is to be distributed. The distribution destination information memory 24a stores a distribution destination information table shown in FIG. 3B, for example.

As shown in FIG. 3B, the distribution destination information table stores a user name 53, a distribution destination (i.e., whereabouts) 54 as the distribution destination information of the user, contact information (e.g., a mobile phone number) 55 as the distribution destination information of the user, in a state in which the distribution destination 54 and the contact information is corresponded to the user name 53. For example, the distribution destination information table stores “Mr. α” as the user name 53, “* factory * floor * room” as the distribution destination (whereabouts) 54, “XXX-XXX-XX” as the contact information (the mobile phone number) 55. It is noted that the distribution destination information means a place at which the addressee receives the fax recorded sheet in an affiliation (e.g., a company and a department) of the addressee which is recorded on the fax recorded sheet.

Further, a Real Time Clock (RTC) 18 is connected to the bus 25. A battery 18a is connected to the RTC 18, so that the RTC 18 can be driven after a power of the MFD 1 is turned off. Where the fax is received in the facsimile function of the MFD 1, the date and time at which the fax is received are obtained from this RTC 18. The date and time are stored, as individual information for identifying the received fax, in the fax-data memory 23a in correspondence with the received fax. That is, the RTC 18 functions as an individual information providing portion configured to provide the individual information.

The ASIC 26 controls, by following commands from the CPU 21, the operations of the printer section 2, the scanner section 3, the operational panel 4 (the operational keys 40 and the LCD 41), the slot portion 72, and so on. To the ASIC 26, there are connected the printer section 2, the scanner section 3, a panel gate array (panel GA) 27 for controlling the operational keys 40, an LCD controller 28 for controlling the display screen of the LCD 41, the slot portion 72, a parallel interface 29 for transmitting and receiving data to and from the external computer via a parallel cable or a USB cable, the USB terminal 71, an amplifier 73 for amplifying a signal outputted from a speaker 74. Further, a Network Control Unit (NCU) 31 is connected to the ASIC 26, and a modem 32 is connected to the NCU 31. The MFD 1 is configured to transmit and receive the fax via the NCU 31 and the modem 32. That is, the ASIC 26, the NCU 31, and the modern 32 mainly constitute a receiving device.

There will be next explained, with reference to a flow-chart indicated in FIG. 4, the received fax recording processing. As described above, this received fax recording processing is the processing in which the user-selected fax which is stored in the fax-data memory 23a is recorded on the recording sheet. In particular, the received fax recording processing is the processing in which the distribution destination of the fax recorded sheet can be recorded by superposing the distribution destination on the images recorded on the recording sheet.

This received fax recording processing is started when one of the function selecting keys 40a which is assigned to the facsimile function is selected and then a “received fax list” button image which is displayed on the LCD 41 by the selection is selected.

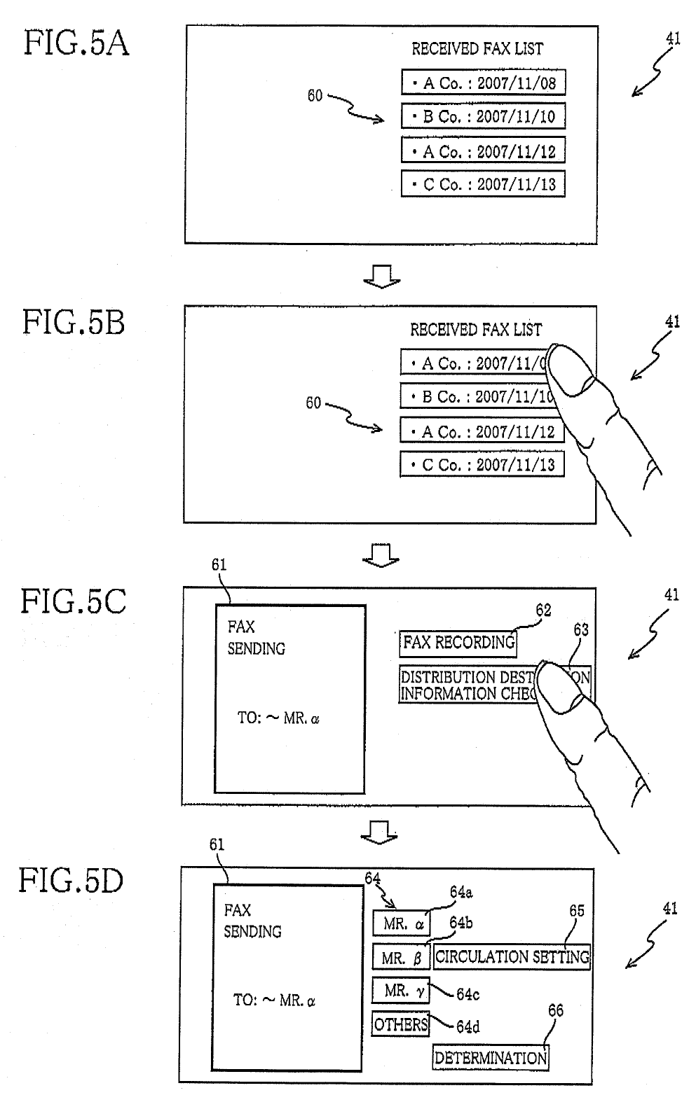

Then, where the “received fax list” button image is selected, a received fax list is displayed on the LCD 41 in S401. As shown in FIG. 5A, a received fax list 60 is displayed on a right portion of the LCD 41. As the received fax list 60, there are displayed, in a list form, received fax histories each including the name of the addresser of the received fax and the date and time at which the fax is received as a pair. For example, there are displayed, in the list form, the received fax histories indicating that a fax from “A Co.” is received on “Aug. 11, 2007”, that a fax from “B Co.” is received on “Oct. 11, 2007”, and that a fax from “A Co.” is received on “Dec. 11, 2007”. It is noted that, as the received fax histories, the name of the addresser and, the date and time are displayed as a pair by identifying the name of the addresser stored in the address memory 23b from the facsimile number of the addresser which is stored in the fax-data memory 23a in correspondence with the date and time.

Then, the controller 80 judges, in S402, whether one of the received fax histories is selected in the received fax list 60 displayed in S401. Where any of the received fax histories is selected (S402: Yes), the fax corresponding to the selected one of the received fax histories is displayed, in S403, on a left portion of the LCD 41. Where any of the received fax histories is not selected (S402: No), a processing in S402 is repeated.

Specifically, as shown in FIG. 5B, where “A Co.:2007/11/08” displayed on a top line in the received fax list 60 is selected, the fax corresponding thereto is read from the fax-data memory 23a. Then, as shown in FIG. 5C, a cover sheet image 61 of the read fax is displayed on the left portion of the LCD 41, and a “fax recording” button image. 62 and a “distribution destination information checking” button image 63 are displayed each as a command button on the right portion of the LCD 41.

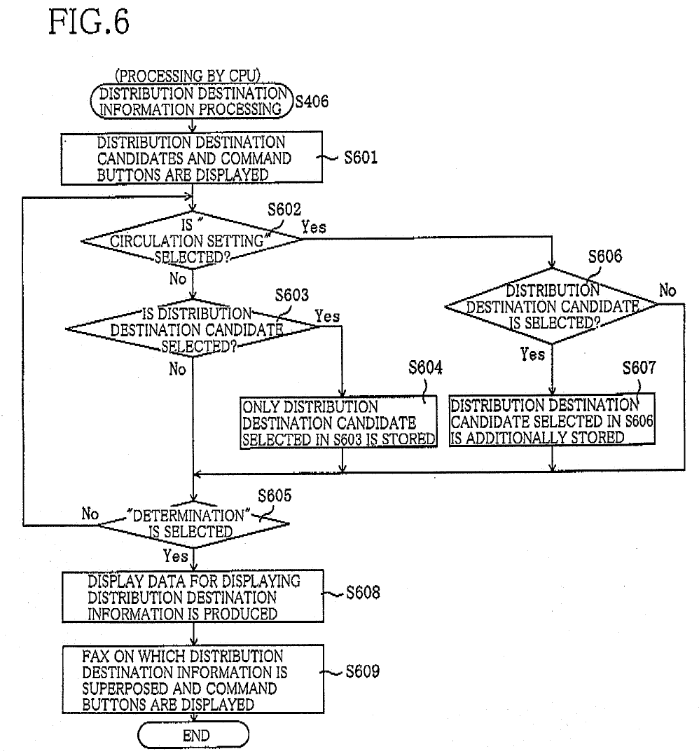

Then, in S404 and S405, the controller 80 judges which one of the “fax recording” button image 62 and the “distribution destination information checking” button image 63 displayed each as the command button in S403 is selected. Where the “fax recording” button image 62 is not selected (S404: No), and the “distribution destination information checking” button image 63 is selected (S405: Yes), the controller 80 performs a distribution destination information processing in S406. This distribution destination information processing is a processing for obtaining distribution destination information indicating the distribution destination of the fax recorded sheet selected in S402. Here, there will be explained, with reference to a flow-chart in FIG. 6, the distribution destination information processing.

In this distribution destination information processing, where the “distribution destination information checking” button image 63 is selected (S405: Yes), candidates of the distribution destination (hereinafter may be referred to as “distribution destination candidates”) and various command button images are displayed in S601 in the right portion of the LCD 41 (i.e., on a right side of the cover sheet image 61 displayed on the LCD 41).

Specifically, as shown in FIG. 5C, where the “distribution destination information checking” button image 63 is selected, as shown in FIG. 5D, there are displayed, on the right portion of the LCD 41, a “Mr. α” button image 64a, a “Mr. β” button image 64b, a “Mr. γ” button image 64c, and an “others” button image 64d as the distribution destination candidates, and a “circulation setting” button image 65 and a “determination” button image 66 each as the command button. That is, the image of the fax and the images of the respective addressee candidates are arranged side by side.

Here, the users stored in the addresses table (with reference to FIG. 3A) in correspondence with the addresser of the fax selected in S402 are displayed as the distribution destination candidates. As a result, users each having a high possibility to be the addressee of the fax recorded sheet can be speedily displayed.

The explanation of the distribution destination information processing will be continued with reference to FIG. 6 again. After the distribution destination candidates and the various command button images are displayed in S601, the controller 80 judges, in S602, S603, and S605, which one of the distribution destination candidates and the various command button images is selected. Where the “circulation setting” button image 65 is not selected (S602: No), and any of the distribution destination candidates is selected (S603: Yes), the distribution destination information stored in the distribution destination information memory 24a which is corresponded to the distribution destination candidates is read, and only the distribution destination information is stored in S604. Then, where the “determination” button image 66 is selected (S605: Yes), display data for displaying on the LCD 41 is produced, in S608, on the basis of the distribution destination information stored in S604. Then, on the basis of the produced display data, the distribution destination information is displayed so as to be superposed on the fax having already been displayed on the left portion of the LCD 41, and the various command button images are displayed on the right portion of the LCD 41 in S609, and this distribution destination information processing is finished.

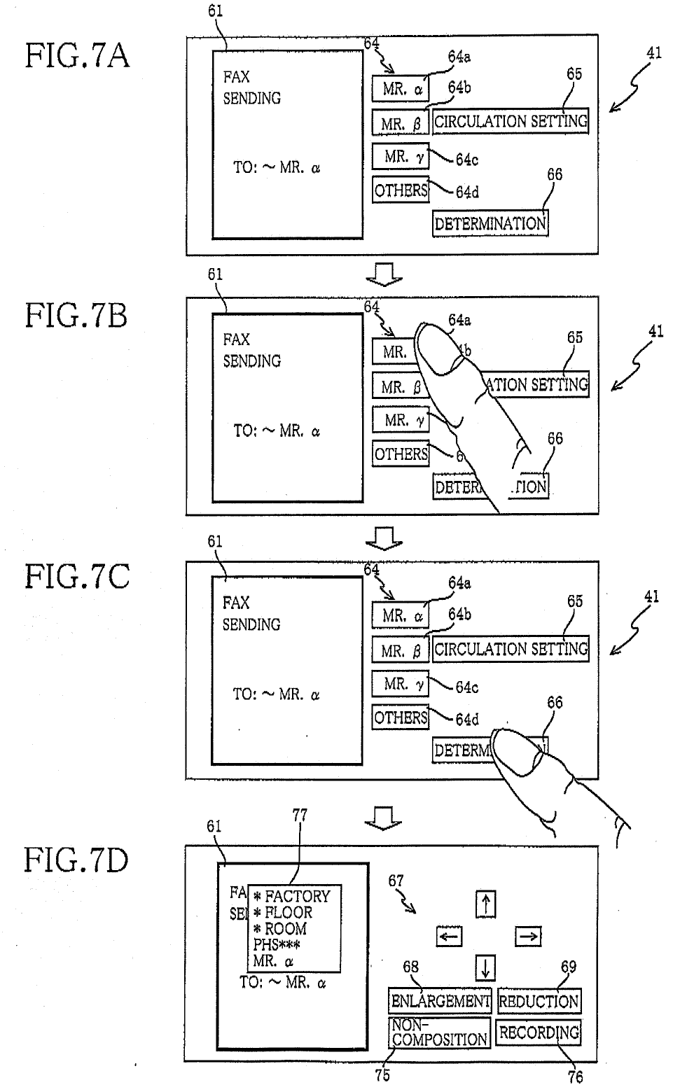

Specifically, among distribution destination candidates 64 displayed on the LCD 41 as shown in FIG. 7A, the “Mr. α” button image 64a is selected as shown in FIG. 7B. Then, where the “determination” button image 66 is selected as shown in FIG. 7C, “* factory * floor * room, PHS***, Mr. α” is displayed as distribution destination information 77 of “Mr. α” so as to be superposed on the cover sheet image 61 as shown in FIG. 7D. Further, in this case, on the right portion of the LCD 41, four “arrow” button images 67 respectively directed in four directions, an “enlargement” button image 68, a “reduction” button image 69, a “non-composition (non-superposing)” button image 75, and a “recording” button image 76 each as the command button. Specifically, each of the “arrow” button images 67, the “enlargement” button image 68, the “reduction” button image 69 functions as an inputting portion through which at least one of a position and a size of the image indicating the distribution destination information 77 which is superposed on the image of the facsimile information is inputted.

As thus described, since the distribution destination information 77 of Mr. α who is the addressee of the fax recorded sheet is displayed on the LCD 41, the distribution destination information, which is attached to the fax, of the addressee of the fax recorded sheet can be speedily checked. Further, a person who operates the MFD 10 to record the fax on the recording sheet and distributes the fax recorded sheet to Mr. α can check the whereabouts of Mr. α and his contact information without effort. Further, as shown in FIG. 7B, where the “Mr. α” button image 64a is selected, since the cover sheet image 61 is displayed on a left side of the distribution destination candidates 64, a distributor of the fax recorded sheet can select the “Mr. α” button image 64a among the distribution destination candidates 64 while checking a name of the addressee, i.e., Mr. α, described in the cover sheet image 61. Thus, selection of wrong addressees (i.e., Mr. β and Mr. γ) among the distribution destination candidates 64 can be prevented. Consequently, the distribution destination information of the addressee of the fax recorded sheet can be correctly checked.

Returning to FIG. 6 again, the explanation is continued. Where the “circulation setting” button image 65 is selected in S602 (S602: Yes), and then any of the distribution destination candidates 64 is selected (S606: Yes), the one of the distribution destination candidates which is selected in S606 is additionally stored in S607.

On the other hand, where the “determination” button image 66 is not selected (S606: No), then the “circulation setting” button image 65 is selected again (S602: Yes), and then any of the distribution destination candidates 64 is selected (S606: Yes), the one of the distribution destination candidates which is selected in S606 is additionally stored in S607.

As thus described, where ones of the distribution destination candidates are selected, and then the “determination” button image 66 is selected (S605: Yes), the processings in S608 and S609 are performed in the above-described manner for each of selected ones of the distribution destination candidates, and this distribution destination information processing is finished.

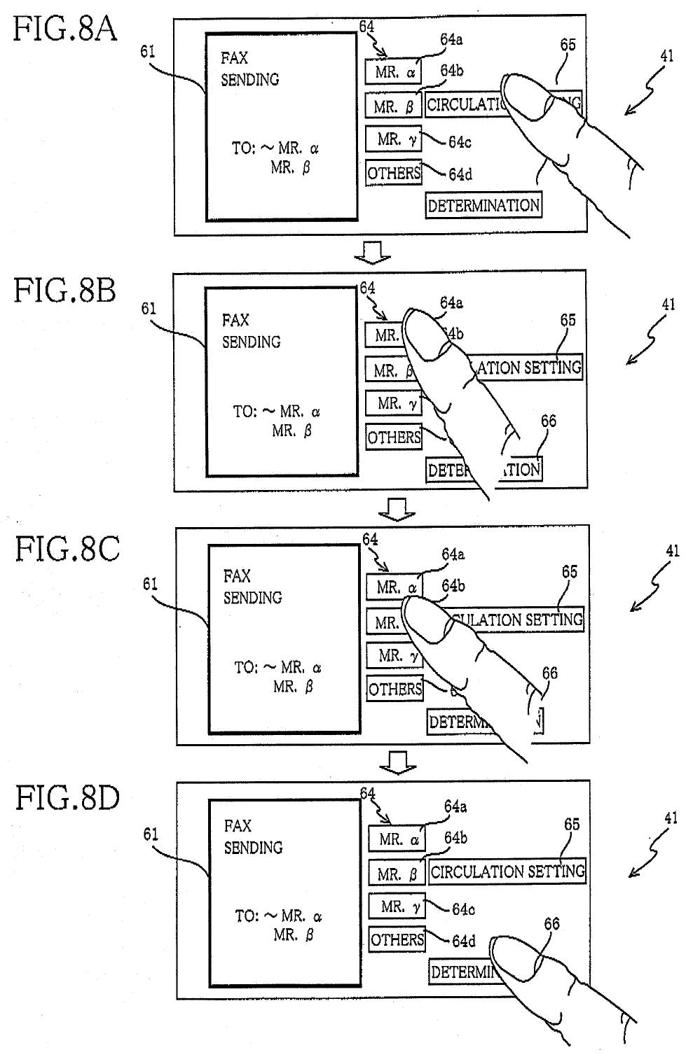

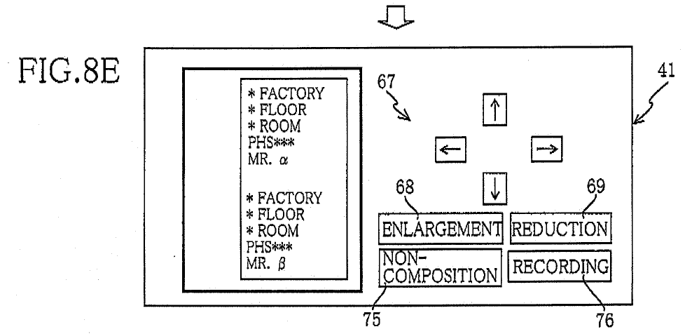

Specifically, the “circulation setting” button image 65 is selected as shown in FIG. 8A, then the “Mr. α” button image 64a is selected as shown in FIG. 8B, then the “circulation setting” button image 65 is selected again as shown in FIG. 8A, then the “Mr β” button image 64b is selected as shown in FIG. 8C, and then the “determination” button image 66 is selected as shown in FIG. 8D.

In this case, as shown in FIG. 8E, on the left portion of the LCD 41, there is displayed distribution destination information 78 including “* factory * floor * room, PHS***, Mr. α” as the distribution destination information of “Mr. α” and “* factory * floor * room, PHS***, Mr. β” as the distribution destination information of “Mr. β” so as to be superposed on the cover sheet image 61. It is noted that, in this case, on the right portion of the LCD 41 are displayed the above-described various command button images.

That is, since this MFD 10 is configured such that a plurality of the distribution destination candidates can be selected by selecting the “circulation setting” button image 65 before any of the distribution destination candidates is selected, where the selected fax is addressed to a plurality of addressees, the distribution destination information 78 of each of the plurality of the addressees can be checked without effort.

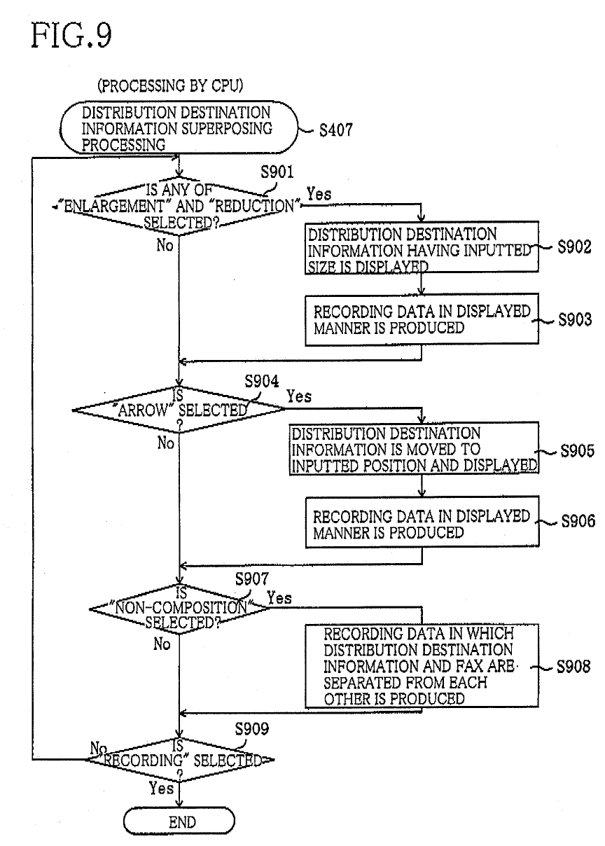

As thus described, where the distribution destination information processing in S406 explained with reference to FIG. 6 is finished, a distribution destination information superposing processing in S407 indicated by a flow-chart in FIG. 4 is performed. This distribution destination information superposing processing in S407 is a processing for producing recording data for recording the fax on the recording sheet. Here, this processing is explained with reference to FIG. 9.

As shown in FIG. 9, in this processing, the controller 80 judges, in S901, S904, S907, and S909, which one of the command buttons displayed in S609 explained in the flow-chart in FIG. 6. As a result, where any of the “enlargement” and “reduction” button images 68, 69 is selected (S901: Yes), the distribution destination information whose size is changed in accordance with an input of the user via the selected one of the “enlargement” and “reduction” button images 68, 69 is displayed on the LCD 41 in S902, and recording data is produced in S903 in a displayed manner. More specifically, a composite image of the cover sheet image 61 and the distribution destination information 77 is produced.

Where any of the “enlargement” and “reduction” button images 68, 69 is not selected (S901: No), and any of the “arrow” button images 67 is selected (S904: Yes), the displayed distribution destination information is displayed in S905 in a state in which a position thereof is moved to a position corresponding to the selected one or ones of the “arrow” button images 67, and recording data is produced in S906 in a displayed manner.

Where any of the “enlargement” and “reduction” button images 68, 69 and the “arrow” button images 67 is not selected (S901: No, S904: No), and the “non-composition” button image 75 is selected (S907: Yes), recording data in which the distribution destination information stored in S604 and S607 in the flow-chart in FIG. 6 and the fax selected in S402 are separated from each other is produced in S908 without changing the display of the LCD 41.

Where any of the “enlargement” and “reduction” button images 68, 69, the “arrow” button images 67, and the “non-composition” button image 75 is not selected (S901: No, S904: No, S907: No), and the “recording” button image 76 is selected (S909: Yes), the distribution destination information superposing processing in S407 is finished. It is noted that, where the “recording” button image 76 is not selected (S909: No), the processings of S901 and the followings are repeated again.

As thus described, where the distribution destination information superposing processing in S407 is finished (that is, a command for recording the fax is inputted), the recording operation is performed in S408 as indicated by the flow-chart in FIG. 4 in accordance with the recording data in S903, S906, and S908, and the received fax recording processing is finished.

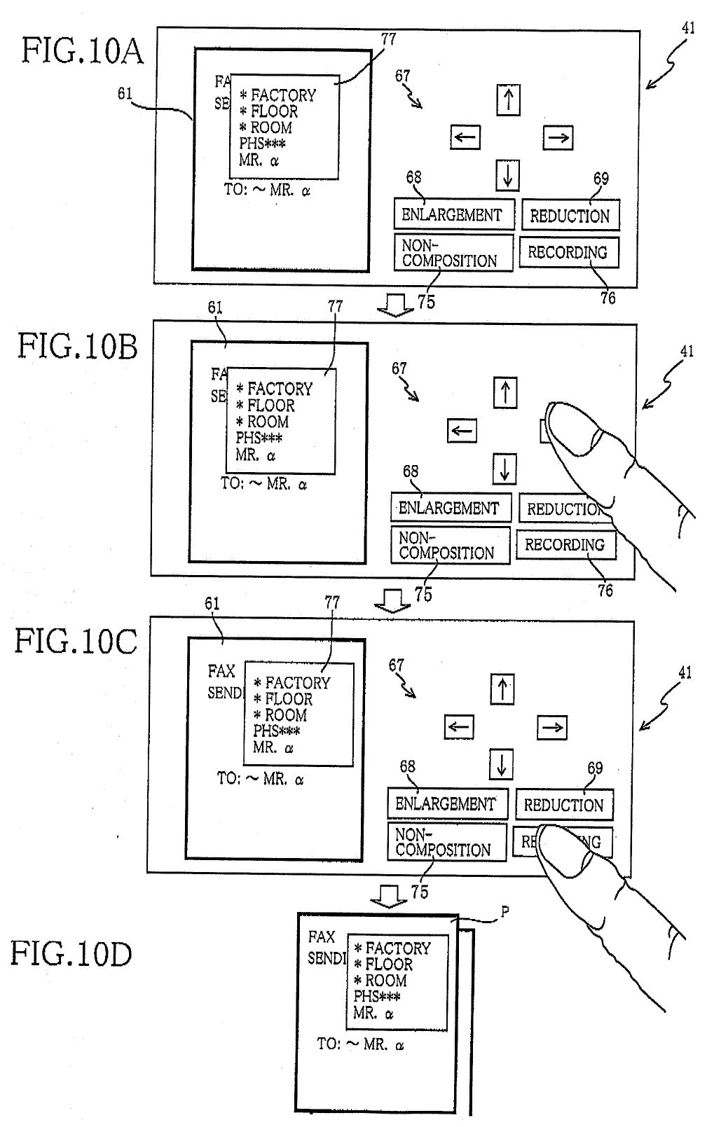

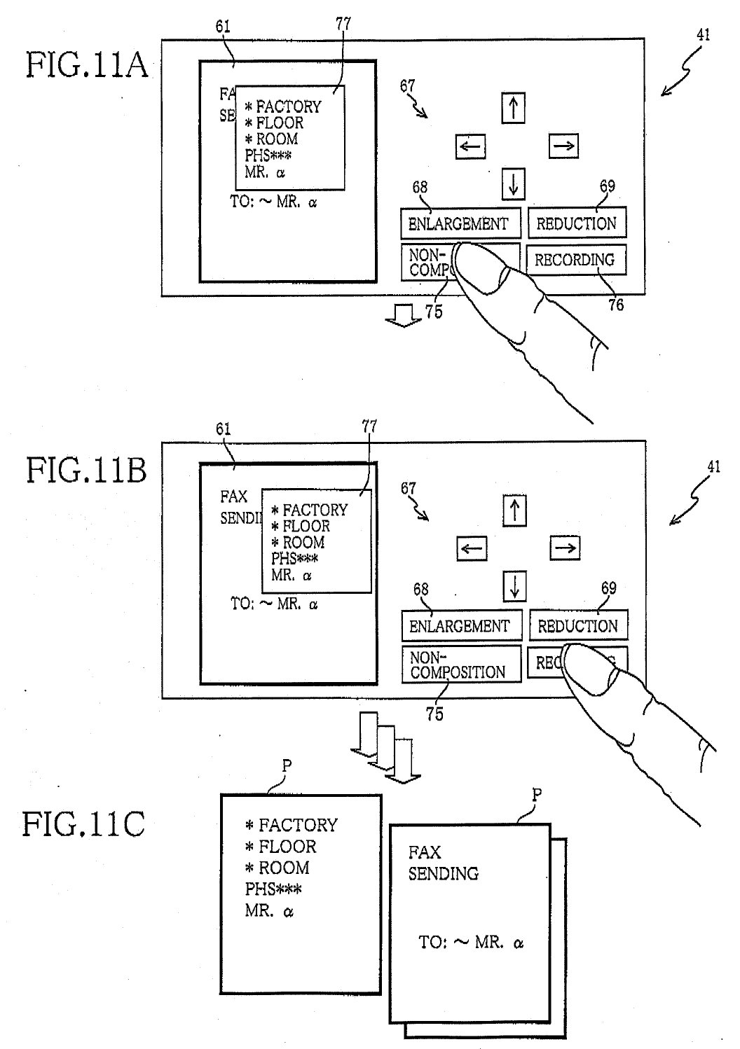

There will be explained, with reference to FIGS. 10A-10D and 11A-11C, this distribution destination information superposing processing more specifically. There is considered a case that in a state in which, as shown in FIG. 10A, there are displayed, on the left portion of the LCD 41, the cover sheet image 61 on which the distribution destination information 77 is superposed and, on the right portion of the LCD 41, the various command button images 67, 68, 69, 75, 76, the “arrow” button image 67a of the various command button images 67 which is directed in a rightward direction is selected as shown in FIG. 10B.

In this case, as shown in FIG. 10A, the distribution destination information 77 displayed on a generally central portion of the cover sheet image 61 is moved in the rightward direction as shown in FIG. 10B. Then, where the “recording” button image 76 is selected as shown in FIG. 10C, an image displayed on the left portion of the LCD 41 (i.e., the cover sheet image 61 on which the distribution destination information 77 is superposed) is recorded on the recording sheet P, and the recording sheet P on which the image is recorded and the recording sheets P on which the fax is recorded are discharged as shown in FIG. 10D.

As thus described, the position and the size of the distribution destination information 77 superposed on the cover sheet image 61 can be suitably set on the cover sheet image 61 by operating the “enlargement” and “reduction” button images 68, 69 and the “arrow” button images 67. This prevents a generation of a case in which the distribution destination information is superposed on the cover sheet image 61, and thus an important part of the cover sheet image 61 cannot be visually recognized. Further, the distribution destination information is recorded on the recording sheet P, thereby eliminating a need of taking the trouble to make a memo of the distribution destination, for example. This provides a convenience for the user.

On the other hand, where the “recording” button image 76 is not selected in a state shown in FIG. 10C, the “non-composition” button image 75 is selected as shown in FIG. 11A, and then the “recording” button image 76 is selected as shown in FIG. 11B, the fax and the distribution destination information are respectively recorded on different recording sheets P, and the recording sheets P are discharged as shown in FIG. 11C.

As thus described, where the “non-composition” button image 75 is selected, the fax and the distribution destination information are respectively recorded on the different recording sheets P, thereby eliminating the need of taking the trouble to make the memo of the distribution destination, for example. Further, only the fax recorded sheets P required for the addressee can be passed to the addressee. It is noted that, in FIGS. 10A-10D and 11A-11C, there has been explained a case that the “arrow” button images 67 or the “non-composition” button image 75 is selected, but it should be understood that where any of the “enlargement” and “reduction” button images 68, 69 is selected, the distribution destination information 77 is enlarged or reduced on the basis of the command and displayed on the LCD 41.

In view of the above, the controller 80 can be considered to include an outputting section which is configured to output the distribution destination information 77 stored in the distribution destination information memory 24a in correspondence with the addressee by adding the distribution destination information 77 to the fax, and which performs the processings of S902, S903, S905, S006, and S908, for example. The outputting section is further configured to output the addressee and the distribution destination information stored in the distribution destination information memory 24a in correspondence with the addressee, and performs the processing of S408, for example.

Further, in view of the above, the controller 80 can be considered to further include a producing section which is configured to produce, according to the at least one of the position and the size which is inputted through any of the “arrow” button images 67, the “enlargement” button image 68, the “reduction” button image 69, the composite image constituted by superposing the image indicating the distribution destination information 77 on the image indicating the fax, and which performs the processings of S903, S906, and S908, for example. In this configuration, the outputting section can be considered to display, on the LCD 41, the composite image produced by the producing section and is configured to record, on the recording sheet, the composite image produced by the producing section.

Further, in view of the above, the controller 80 can be considered to further include (a) a facsimile information displaying section which is configured to display the fax stored in the fax-data memory 23a and which performs the processing of S403, for example, and (b) an addressee candidate displaying section which is configured to display the addressee candidate(s) and which performs the processing of S601, for example.

Further, in view of the above, the controller 80 can be considered to further include a selecting section which is configured to select any of the addressee candidate(s) displayed on the LCD 41 and which performs the processings of S603 and S606, for example. In this configuration, the outputting section is configured to output the distribution destination information 77 stored in the distribution destination information memory 24a in correspondence with the addressee candidate(s) which has or have been selected by the selecting section. In this case, the controller 80 can be considered to perform the processings of S608 and S609.

Further, in view of the above, the controller 80 can be considered to further include a history displaying section configured to display the received fax histories including the individual information and the addresser of the fax which corresponds to the individual information and which performs the processing of S401, for example.

Further, in view of the above, the controller 80 can be considered to further include a specifying section configured to specify one of the facsimile histories displayed on the LCD 41 and which performs the processing of S402, for example.

It is to be understood that the above-described embodiment is described only by way of example, and the invention may be otherwise embodied with various modifications without departing from the scope and spirit of the invention.

In this embodiment, there has been explained (a) the case that the fax and the distribution destination information are recorded on the recording sheet P such that the distribution destination information is superposed on the fax, and the recording sheet P is discharged, and (b) the case that the fax and the distribution destination information are respectively recorded on the different recording sheets P, and the recording sheets P are discharged. However, the MFD 1 may be configured such that the fax and the distribution destination information are displayed on the LCD 41 such that the distribution destination information is superposed on the fax, and only the fax is recorded on the recording sheet P, and the recording sheet P is discharged. In this case, the distribution destination can be checked from the distribution destination information displayed on the LCD 41 without effort. In addition, only one or ones of the recorded sheets P on which only the fax required for the addressee is or are recorded can be passed to the addressee, and useless consumption of the recording sheets can be prevented.

Further, in the above described embodiment, there has been explained the case that the fax and the distribution destination information are displayed such that the distribution destination information is superposed on the fax, but the distribution destination information may not be necessarily displayed on the LCD 41 so as to be superposed on the fax. That is, the MFD 1 may be configured such that the distribution destination information is displayed so as to be separated from the fax. In this case, there can be prevented a generation of a case that a content of the fax cannot be visually recognized by being hidden by the distribution destination information. Further, the distribution destination information is displayed on the LCD 41 or recorded on the recording sheet P, but the MFD 1 may also be configured such that the distribution destination information is outputted as a voice from the speaker 74.

What is claimed is:

1. A facsimile apparatus, comprising:
a receiving device configured to receive facsimile information;
a facsimile information storing device configured to store the facsimile information received by the receiving device;
a distribution destination storing device configured to store an addressee of the facsimile information and distribution destination information indicating a distribution destination of the facsimile information addressed to the addressee, in a state in which the distribution destination information is corresponded to the addressee; and
a controller configured to execute controls for operations of the facsimile apparatus,
wherein the controller includes an outputting section configured to output the distribution destination information stored in the distribution destination storing device in correspondence with the addressee.

2. The facsimile apparatus according to claim 1,
wherein the outputting section is further configured to output the facsimile information with the distribution destination information corresponded to the addressee of the facsimile information.

3. The facsimile apparatus according to claim 1, further comprising a display device,
wherein the controller includes a producing section configured to produce a composite image constituted by superposing an image indicating the distribution destination information on an image indicating the facsimile information, and
wherein the outputting section is configured to display, on the display device, the composite image produced by the producing section.

4. The facsimile apparatus according to claim 1,
wherein the controller further includes a producing section configured to produce a composite image constituted by superposing an image indicating the distribution destination information on an image indicating the facsimile information, and
wherein the outputting section is configured to record, on a recording sheet, the composite image produced by the producing section.

5. The facsimile apparatus according to claim 3, further comprising an inputting portion through which at least one of a position and a size of the image indicating the distribution destination information which is superposed on the image indicating the facsimile information is inputted,
wherein the producing section is configured to produce the composite image according to the at least one of the position and the size which is inputted through the inputting portion.

6. The facsimile apparatus according to claim 1,
wherein the outputting section is configured to record the facsimile information and the distribution destination information respectively on recording sheets which are different from each other.

7. The facsimile apparatus according to claim 1,
wherein the outputting section is configured to display the distribution destination information and to record only the facsimile information on a recording sheet.

8. The facsimile apparatus according to claim 1, further comprising an addressee candidate storing device configured to store at least one addressee candidate of the facsimile information stored in the facsimile information storing device,
wherein the controller further includes (a) a facsimile information displaying section configured to display the facsimile information stored in the facsimile information storing device and (b) an addressee candidate displaying section configured to display the at least one addressee candidate.

9. The facsimile apparatus according to claim 8,
wherein the addressee candidate displaying section is configured to display the at least one addressee candidate in a state in which the at least one addressee candidate and the facsimile information displayed by the facsimile information displaying section are arranged side by side.

10. The facsimile apparatus according to claim 8,
wherein the controller further includes a selecting section configured to select any of the at least one addressee candidate displayed by the addressee candidate displaying section, and
wherein the outputting section is configured to output the distribution destination information stored in the distribution destination storing device in correspondence with the at least one addressee candidate which has been selected by the selecting section.

11. The facsimile apparatus according to claim 10,
wherein the outputting section is configured to output (a) the facsimile information displayed by the facsimile information displaying section and (b) the distribution destination information in correspondence with the at least one addressee candidate which has been selected by the selecting section, by adding the distribution destination information to the facsimile information.

12. The facsimile apparatus according to claim 10, further comprising an individual information providing portion configured to provide individual information which is for identifying the facsimile information received by the receiving device,
wherein the controller further includes:
a history displaying section configured to display at least one received facsimile history including the individual information provided by the individual information providing section and an addresser of the facsimile information which corresponds to the individual information; and
a specifying section configured to specify one of the at least one received facsimile history displayed by the history displaying section,
wherein the facsimile information displaying section is configured to display the facsimile information corresponding to the one of the at least one received facsimile history which has been specified by the specifying section,
wherein the addressee candidate storing device is configured to store the at least one addressee candidate and the addresser of the facsimile information which sends the facsimile information to the at least one addressee candidate in a state in which the addresser of the facsimile information are corresponded to the at least one addressee candidate, and
wherein the addressee candidate displaying section is configured to display the at least one addressee candidate stored in the addressee candidate storing device in correspondence with the addresser of the facsimile information corresponded to the one of the at least one received facsimile history which has been specified by the specifying section.

13. The facsimile apparatus according to claim 10,
wherein where the selecting section has selected a plurality ones of the at least one addressee candidate, the outputting section is configured to output the distribution destination information which is corresponded to each of the plurality ones of the at least one addressee candidate.

14. The facsimile apparatus according to claim 10,
wherein where the facsimile information is circulated, the selecting section is configured to select a plurality ones of the at least one addressee candidate, and the outputting section is configured to output the distribution destination information which is corresponded to each of the plurality ones of the at least one addressee candidate.

15. The facsimile apparatus according to claim 10,
wherein where the selecting section has selected only one of the at least one addressee candidate, the outputting section is configured to output only the distribution destination information which is corresponded to the one of the at least one addressee candidate.

16. The facsimile apparatus according to claim 1,
wherein the outputting section is configured to output the addressee and the distribution destination information stored in the distribution destination storing device in correspondence with the addressee.

17. A method of outputting distribution destination information, the method comprising the steps of:
(a) receiving facsimile information addressed to an addressee;
(b) specifying, on the basis of the facsimile information received in step (a), distribution destination information that indicates a distribution destination of the received facsimile information and that is stored in correspondence with the addressee; and
(c) outputting the distribution destination information specified in step (b) in correspondence with the addressee.
